(19) United States
(12) Patent Application Publication
(10) Pub. No.: US 2006/0051162 A1
(43) Pub. Date: Mar. 9, 2006

(54) Rotating containment tool for contaminated sediment remediation in an aqueous environment

(76) Inventors: Warren Chesner, Oceanside, NY (US); Gregory W. Maxwell, Acton, MA (US)

Correspondence Address: ALFRED M. WALKER, 225 OLD COUNTRY ROAD, MELVILLE, NY, 11747-2712, US

(21) Appl. No.: 11/218,831

(22) Filed: Sep. 3, 2005

Related U.S. Application Data
(60) Provisional application No. 60/607,726, filed on Sep. 7, 2004.

(51) Int. Cl. B65G 5/00; B09C 1/00

(52) U.S. Cl. 405/57; 405/128.15; 405/58

(57) ABSTRACT

A rotating cylindrical containment tool that removes contaminated sediment and prevents the dispersion of contaminated sediments during excavation. The tool casing is rotated and is forced down into the sediment whereby the sediment rises up into the interior of the casing. Water flows into and out of the casing based on external and internal pressures. After the sediment rises into the cylindrical casing a feed auger assembly extending therefrom is utilized to deliver materials and/or cap the excavated void space in the sediment. Alternatively, the rotating containment tool prevents the dispersion of contaminated sediments and treats contaminated sediment in situ with treatment reagents, in the sub-aqueous environment.

### RELATED APPLICATIONS

This application is based upon provisional application No. 60/607,726 filed Sep. 12, 2004 and claims priority benefit under 35 U.S.C. 119(e) therefrom.

### FIELD OF THE INVENTION

This application relates to tools for remediation of contaminated sediment in an aqueous environment.

### BACKGROUND OF THE INVENTION

In recent years, the ecological impacts associated with the presence of subaqueous contaminated sediments in many lakes, rivers and estuaries in the U.S. have reached significant severity to warrant regulatory and in some cases enforcement actions against responsible parties, by Federal, state, and local authorities, to remediate the problem. Planners and engineers responsible for designing remediation strategies for such subaqueous contaminated sediment sites have a limited number of options from which to choose. The primary options available fall into three categories: 1) natural attenuation, 2) sediment removal, and 3) in-situ management.

Natural attenuation is a passive (no-action) strategy that permits natural processes to degrade or disperse the contamination present in the sediment. Sediment removal and in-situ management can be categorized as active strategies.

Sediment removal is commonly referred to as dredging. It involves extracting the contaminated sediment from the bottom of the waterway and disposing of the sediment at a secure location. Basic sediment removal or dredging technology employs one of two general approaches: 1) mechanical dredging, or 2) hydraulic dredging. Mechanical dredging makes use of clamshell buckets to scoop out and remove the sediment. Hydraulic dredging removes sediment by agitating the bottom of the waterway and vacuuming the dislodged sediment particles.

In-situ management can be divided into two general subcategories. These include sediment isolation and in-situ treatment.

Sediment isolation typically involves some form of capping, which is a strategy that is designed to cover the contaminated sediment with selected materials to prevent the contamination from migrating from the site. This migration could result from particulate erosion, dissolution into the water column or biological transfer through the sediment-water interface. The sediment-water interface or the subsurface sediment line is an active biotic zone where bottom dwelling organisms can transfer absorbed or ingested contaminants up the food chain to higher organisms. Capping materials can consist of clean sand or stone. More recently, research has focused on the deployment of active caps, which are caps that employ materials that can react with contaminants to prevent soluble contaminants from migrating through the cap.

In-situ treatment is a developing technology. It involves a process where contaminants present in the sediment are not removed, but remediated in-place. Alternative forms of in-situ treatment include the addition of treatment reagents or amendments to the sediment to physically, biologically, or chemically stabilize or sequester contaminants in the sediment, or alternatively, to destroy the chemical constituents (e.g., organic molecules) that comprise the contamination. The successful development of in-situ technology would eliminate the need to physically remove such sediments from the water. This is a tantalizingly attractive management strategy since it could potentially eliminate the high cost and environmental disruption associated with the dredging of contaminated sediments.

Each of the active management strategies has some serious limitations with respect to the overall effectiveness and efficiency of the respective approach.

With respect to sediment removal or dredging technology, one of the more notable limitations is the unavoidable disruption of the subsurface sediment and loss of sediment stability that occurs during the dredging process, and the resulting migration of contaminants from the dredge site to downstream locations. In addition, recent data suggest that there is significant uncertainty as to whether dredging alone can adequately remediate subaqueous contaminated sediment sites. A recent USEPA study, which provided post-dredging contamination data at seven polychlorinated biphenyl (PCB) contaminated sediment sites where dredging was employed as the remediation technology and where sufficient data were available to evaluate the results, showed PCB reduction at all sites, but not one achieved average residual PCB concentrations in the sediment of less than one part per million (ppm) after dredging, even after multiple dredging passes (United States Environmental Protection Agency, Statement of the Engineering Performance Standards for Dredging, Volume I, USEPA, Region 2, April 2004). One ppm (or less) is an approximate concentration level that many PCB cleanup projects are presently targeting as the desired post-cleanup level of residual contamination for risk reduction. Concern associated with the expected efficiency of cleanup resulting from dredging technology is presently acknowledged by many experts involved in dredging remediation activity and is presently the subject of serious concern (Bridges, T. S. How Do We Make Risk Management Decisions, Battelle, New Orleans, Jan. 24-27, 2005; Doody, J. P, Case Studies of Environmental Dredging Projects, Third International Conference on Remediation of Contaminated Sediments, Battelle, New Orleans, Jan. 24-27, 2005)

The capping of contaminated sediments after dredging with sand, stone, or other materials is designed to prevent the upward migration of residual contaminants and/or to provide a clean subsurface bed of sediment that can be colonized by uncontaminated organisms is currently being considered on many projects. Capping alone could be used as a strategy to eliminate the need for dredging or could be used in conjunction with dredging to cover dredged locations with a clean layer of material where target cleanup goals cannot be achieved. Capping is most commonly undertaken in field operations using clamshell buckets to deposit the fill or capping materials over the target areas. There are several limitations associated with capping technology. Probably the most notable is the design and placement of capping materials in such a manner that the cap will be capable of withstanding the long-term erosive forces of the designated waterway. In addition there is also a need to place the capping material in a manner that minimizes the momentum of the material as it contacts the subsurface to avoid dispersing the bottom sediments. Finally, there is a need to place the capping material in precise layers to ensure design thicknesses are achieved.

As previously noted, in-situ treatment is a developing strategy. To-date, actual in-situ field applications that have been reported have focused on the use of horizontal rakes or horizontal augers to mix reactants into the sediment. In a horizontal rake system, the reactant is introduced through a hollow stem, which is incorporated into the raking mechanisms. In a horizontal auger system the reactant is introduced through a separate feed hose that is incorporated into the auger. Adequate mixing of the reagents with the soil and sediment dispersion are two major limitations. Paradoxically, while adequate mixing is necessary to effectively deliver reagents to a subaqueous contaminated sediment, such mixing will destabilize the sediment resulting in similar, but perhaps more aggravated, dispersion problems than those associated with dredging technology.

In summary, each of the active remediation approaches (i.e., sediment removal, capping and in-situ treatment) has significant limitations. Dredging and in-situ treatment can be expected to induce subsurface instability and contaminant dispersion during operations. Capping technology is limited by the ability to place a capping material in a precise and accurate manner, with minimal subsurface disturbance at a designated location and ensure that the cap will remain in-place and will not be impacted by the erosive forces in the waterway.

At the present time the solution to the dispersion problem relies heavily on the use of containment barriers, such as silt curtains or fixed sheet piles for containing the sediments dispersed during dredging or capping operations. Silt curtain use is limited to waterways with low currents (typically less than one knot). Fixed sheet pile installation severely limits the mobility and flexibility of dredging operations. Since fixed sheet piles are not easily relocated, a large area is typically enclosed, inside which dredging operations occur. This means that all equipment (dredging and solids handling barges) will usually be trapped inside the sheet pile barrier for the duration of the project (unless the dredging equipment can be deployed on land). If contamination is widespread, over a large non-contiguous area, several fixed sheet pile barriers may be needed. Finally, if adequate space is not available, navigation on the waterway can be hampered for an extended time (until the operation is completed). In addition and perhaps most problematic is the fact that both silt curtain and fixed sheet pile containment suffer from the critical environmental limitation that the contained sediments present in the destabilized sediment layer are free to migrate from the site once the respective barriers are removed.

There have been numerous attempts over the years to produce improved dredging equipment to mitigate dredging dispersion problems. Many of the alternative equipment options are described elsewhere (Herbich, Handbook of Dredging Engineering, 2^{nd} Edition, 2000). In practice however, silt curtains and sheet piles are almost exclusively used as remedies.

Chesner U.S. Pat. No. 6,712,979, describes a clamshell bucket enclosed in a housing for working in sub-aqueous environments. Chesner '979 uses pressure control as a means to minimize dispersion of sediments.

While clamshell buckets, vacuum heads, and even backhoes have been employed in the removal of subaqueous sediments, rotating digging tools such as augers have rarely been used.

Recently, in the construction industry, the use of rotating digging tools have been employed within hollow tubular casings as a means to provide for the in-place casting of piles in the ground. The casing acts as a means to support the sidewalls of the excavated hole and provides a form for the pile. A special apparatus for boring into the ground within a casing is described by Kato U.S. Pat. No. 6,540,443 B2. Methods for casting piles in place inside a hollow casing have been described by Dewitt U.S. Pat. No. 6,773,208 B2, Beck U.S. Pat. No. 6,048,137, Lin U.S. Pat. No. 4,915,544. Casting piles in-place involves the extraction of soil from the hollow casing and the introduction of concrete or grout as a backfill material. Stannard U.S. Pat. No. 4,152,089 described a method for forming a cast-in-place support pile where pressurized concrete is introduced into an excavated hole to form a column.

In recent years, double rotary drilling has been introduced by equipment suppliers (Liebherr Crane Co., Flourtown, Pa.). Double rotary drilling systems provide for the simultaneous rotation, in opposite directions, of an outer casing and inner auger. The counter rotation of the casing and auger offsets the torque on the drive mechanism.

An additional piece of equipment, a drilling bucket, is a common tool used in foundation construction applications to excavate soils from circular excavations needed for the construction of piles, columns or cutoff walls when augers are not able to extract material from a drilled hole. This can happen when wet or cohesionless materials are encountered. Drilling buckets may also be appropriate when heavy gravel or cobbles are encountered. Drilling buckets have a cutting edge that forces material into the bucket during rotation. When the drilling bucket is full, the bucket is spun in the direction opposite of drilling to close the built-in flaps, which prevent the cuttings from falling out of the bucket. The bucket is then extracted from the drilled hole and emptied.

While drilling buckets have not been previously considered as a subaqueous contaminated sediment remediation tool, one novel concept, which makes use of drilling buckets, has recently been proposed by an environmental remediation company, Sevenson Environmental Services, Inc., headquartered in Niagara Falls, N.Y. The Sevenson concept is referred to as “caisson dredging.” In this technology a large diameter steel caisson (approximately 10 ft) is driven into the sediment and the water is decanted. The caisson is driven to sufficient depth below the sediment to produce a seal to prevent outside water from entering the caisson. Dredging is accomplished by a specialty type drill-head that is positioned and secured on top of the decanted caisson. A drill bucket is lowered from the drill-head and is used to extract the impacted sediment. The caisson is subsequently backfilled to bring the subsurface sediment back to its original grade. Finally the caisson is withdrawn and repositioned to repeat the process. The process mitigates the dispersion problem and provides a means of capping the sediment in a controlled manner. In this application the caisson is used as a containment tool to prevent the migration of contamination from the excavation. The process is also touted, by the developer, as an approach that can be used to dredge contaminated sediment near an existing structure, such as a wharf or bridge without impacting the integrity of the structure. Caisson dredging technology is limited however by the cumbersome, slow and expensive operational sequence, primarily associated with driving a long, large diameter steel caisson into the subaqueous sediment to prepare a containment area for each excavation.

### OBJECTS OF THE INVENTION

The object of the invention presented in this patent is to provide a subaqueous contaminated sediment remediation tool that can prevent the migration of contaminants during sediment removal, capping and in-situ treatment operations and provide for secure and precise placement of capping material.

### SUMMARY OF THE INVENTION

The invention provides for contaminated sediment remediation in an aqueous environment using a rotating containment tool. Remediation is accomplished by either excavation of contaminated sediment, or by in situ treatment thereof.

The invention includes a rotating cylindrical casing that can be employed in contaminated sediment remediation operations to provide the means to conduct remediation operations inside the cylindrical casing, thereby preventing the migration of contaminants from the subject site. The inventors have introduced new components and adapted the cylindrical casing to accommodate the operations necessary for 1) sediment removal, 2) sediment capping and 3) in-situ treatment of the subaqueous sediment.

The rotating cylindrical casing, as defined in this invention, can be compared to the operation of the above-referenced drilling bucket used in foundation construction. Drilling buckets are driven by rotary drilling machines that can be powered hydraulically, pneumatically, electrically, or mechanically. Rotary drilling machines are used to bore holes for exploration, shafts, caissons, or in-situ piles. Rotary drilling machines of a similar type can be used to support and drive the rotating containment tool described in this invention.

The inventors have introduced substantive modifications into the basic features of drilling buckets used in foundation industry operations to enable the bucket to function as a containment tool that can operate in a submerged, underwater environment and as such can support sediment removal, capping and in-situ treatment operations discussed previously.

The initial modification provides for the evacuation of water that will enter the casing or containment tool during submergence below the water surface. Unless special provisions are provided, the casing will fill with water and the pressure induced by the presence of this water inside the casing will prevent sediment from entering the casing. The inventors have devised several approaches to address this issue.

The first approach provides for the incorporation of pressure-release ports at the top of the casing to permit water to flow into and out of the casing as external and internal pressures dictate. As a result, as sediment enters the casing from the bottom, the water present in the internal casing can freely exit through the top.

Additionally, during excavation operations the inventors have incorporated an optional sliding bladder system inside the casing to prevent incoming sediment from mixing with overlying water and dispersing into the external water column.

An alternative approach provided by the inventors is to collect and pump water that enters the casing to the surface for treatment. This approach incorporates the use of pressure-release ports that would be connected to the surface where the water could be pumped to a treatment system prior to release to the ambient water column.

Finally the inventors have included a water-free alternative that prevents the entry of water into the casing during descent through the water column. This is accomplished by employing a pressure-controlled casing. By pressurizing the casing with compressed air, equivalent to that of the external hydrostatic pressure and releasing pressure appropriately to permit the entry of sediment into the casing, the casing can be kept water-free during remediation operations.

The need to separate or treat water present in the casing from incoming sediments will be dependent on the potential for the sediment to mix with the water and disperse through pressure-release ports into the water column. In many instances such measures may be unnecessary. Nevertheless, the inventors have included modifications in this invention to address this issue if warranted. It is understood that any of these approaches or other casing water management strategies might be incorporated into the operation without departing from the scope of the invention.

When used for sediment removal, the rotating containment tool operates similar to a drilling bucket, with one of the aforementioned water evacuation mechanisms. It is equipped with a rotating door(s) on the bottom of the casing that permits the sediment to enter the casing during subsurface penetration and casing rotation. When the casing fully penetrates the sediment, the rotation is reversed. This reversed rotation closes the door(s) to contain the sediment as it is removed from the excavation. Sediment is discharged from the casing by lifting the casing out of the water and swinging it onto the surface of a vessel or dry land and over a container or drop area. The hinged bottom of the casing, which contains a watertight seal, is subsequently opened to permit the sediment to drop out of the casing.

Excavating a circular hole in a subaqueous sediment environment will, in almost all cases, result in the formation of an unstable void space that will be susceptible to the collapse of the unsupported sidewall in the excavated hole. To remedy this situation the inventors have included a backfill or capping material delivery system that provides for the replacement of the removed sediment with clean fill. Such replacement, which is preferably provided with a feed auger located inside a hollow pipe, serves not only to stabilize the hole, mitigating the wall instability problem, but provides for a clean cap on top of the excavated sediment.

In effect, the inventors have devised a sediment excavation and capping system that excavates the contaminated sediment in a contained environment, inside the rotating casing, thereby preventing the release of contaminants into the surrounding waterway, while providing the means to leave a clean layer of sediment at the sediment-water interface. Unlike the caisson dredging process described above, the drilling bucket acts as the excavation tool and the containment tool for both the excavation and capping processes. The invention provides the means to excavate to any desired depth and cap the exact location of the excavated hole. No other equipment are available that can excavate contaminated sediment and cap in one operation.

When used for in-situ treatment operations, the rotating containment tool is employed as an open bottom drilling bucket that bores down to the desired design depth with the sediment to be treated rising up into the rotating casing. The casing contains a hollow stem that runs down the center with mixing blades extended from the stem, inside the casing, to provide the means to deliver and mix either liquid or solid particle treatment reagents and the sediment in a contained manner. Alternatively, gaseous reagents under pressure could be introduced, if suitable for treatment. During in-situ operations the casing must also penetrate the sediment, and water within the casing must be evacuated to relieve the internal casing pressure, as described above. In an in-situ mixing environment, employment of a protective bladder system is not practical, as will be shown, due to the presence of mixing blades within the casing. Water must be controlled by one of the other aforementioned approaches.

While during mixing operations sediment will be contained inside the rotating casing, the mixed sediment will be destabilized and will be susceptible to migration after the containment tool is removed. Such migration can be mitigated by employing some additional operational approaches. One approach is to stagger the treated holes in a predefined pattern so that the excavations are not contiguous. Staggering the treated holes maintains stable sediment around the treated hole thereby preventing the uncontrolled dispersal of sediment that has been destabilized. With time, the treated sediment will consolidated and treatment can occur in the untreated portions in a similar staggered pattern. Alternatively, backfill or capping material can be placed on top of the treated sediment hole by deploying an auger down the hollow stem of the mixing tool to deliver capping material to treated location after mixing and treatment is completed. Capping material, as will be shown below, can be delivered through a bottom plug in the hollow stem reagent delivery pipe.

Whether sediment removal or in-situ treatment is considered as the remediation option, the design depth or height of the casing that is employed during a remediation operation can be set to the desired depth of remediation. For example, if 3 feet of contaminated sediment is planned for removal or treatment, then a casing that will penetrate 3 feet of sediment can be used. Such a system can provide sediment removal or in-situ treatment precision (with respect to vertical penetration) that is not available using conventional techniques.

In a situation where sediment removal and capping is desirable, the removal of 3 feet of sediment would also include the delivery of 3 feet of clean capping material, such as sand, to seal residual contamination that may be present below the cut and to provide a clean subsurface upon which a new biological community can be reestablished. Any residual contamination left in the sediment would be covered by 3 ft of capping material. No other capping procedure is available that can provide the precision offered by such an approach. During in-situ treatment operations, the depth of the casing will be somewhat greater than the design treatment depth due to the expansion that will occur as a result of the introduction of reagents and bulking of the sediments that will result from subsurface mixing.

The diameter of the rotating casing can vary over a wide range, but in most cases can be expected to be between 3 feet and 8 feet in diameter. The larger the diameter, the greater will be the productivity in terms of the volumetric remediation rate (e.g., cubic yards per day).

The use of a cylindrical casing for remediation containment will result in a circular grid pattern in the subsurface environment. As noted above, staggering the treated pattern will be advantageous when subaqueous sediment stability is a concern. Ultimately however, to treat a contiguous area, a circular grid pattern will unavoidably require overlap from one location to another to ensure that the entire subsurface is undergoing treatment. While such overlap might be advantageous in ensuring complete treatment coverage and in-situ applications, it will, during excavation operations, result in the removal of clean capping material previously placed. To minimize the amount of material re-excavated, an operational approach that utilizes a larger diameter casing for primary excavation holes followed by a smaller casing for secondary excavation holes is a preferred strategy.

The differences between the sediment removal and capping functions of the rotating containment tool and its function as an in-situ contaminated sediment treatment device are as follows:

The sediment removal device has a bottom door that can seal to prevent leakage after the sediment is pushed up into the bucket. In contrast, the in-situ system has an open bottom.

Both the sediment removal device and the in-situ device have a hollow stem that extends down the center of the containment tool. However in the sediment removal device this stem is used to house a feed auger that can deliver capping material to the excavated hole through the auger assembly plug.

In contrast, in the in-situ treatment device, this stem can be used in one of two ways. First, it can deliver under pressure liquid reagents or slurries out through holes in the mixing blades to blend with the sediment present in the containment tool, or, secondly, it can be used in the same manner as the sediment removal tool, where it delivers solid particles (such as, for example, a solid reagent) down through the auger assembly plug to be mixed by the mixing blades, or capping material to cap the area that has been mixed, in order to prevent the destabilized sediment from dispersing after the containment tool is extracted from the treated location.

In summary, the invention is intended to provide a contained remediation action in one continuous operation, resulting in a savings in cost while achieving a high assurance that the goals for the remediation are being achieved.

### BRIEF DESCRIPTION OF THE DRAWINGS

The following drawings are included herein to provide a more detailed description of the subject invention as it relates to sediment removal (dredging), capping and in-situ treatment operations. While the present invention can best be understood in connection with the accompanying drawings, it is further noted that the invention is not limited to the precise embodiments shown in drawings.

FIG. 1 is a side crossectional view of the rotating containment tool of the present invention, shown in an excavation mode penetrating the subsurface.

FIG. 2 is a side crossectional elevation view of the rotating containment tool in an excavation mode in mid-penetration into sediment.

FIG. 3 is a side crossectional elevation view of the rotating containment tool in an excavation mode fully penetrated into sediment.

FIG. 4 is a side crossectional elevation view of the rotating containment tool in an excavation mode extracting the sediment.

FIG. 5 is a side crossectional elevation view of the rotating containment tool in an excavation mode fully extracted from the sediment.

FIG. 6A is a close-up partial side crossectional elevation view of the rotating containment tool.

FIG. 6B is a bottom view of the rotating containment tool.

FIG. 7A is a close-up partial side crossectional elevation view of the rotating containment tool in an in-situ mode.

FIG. 7B is a bottom view of the rotating containment tool.

### DETAILED DESCRIPTION OF THE SYSTEM

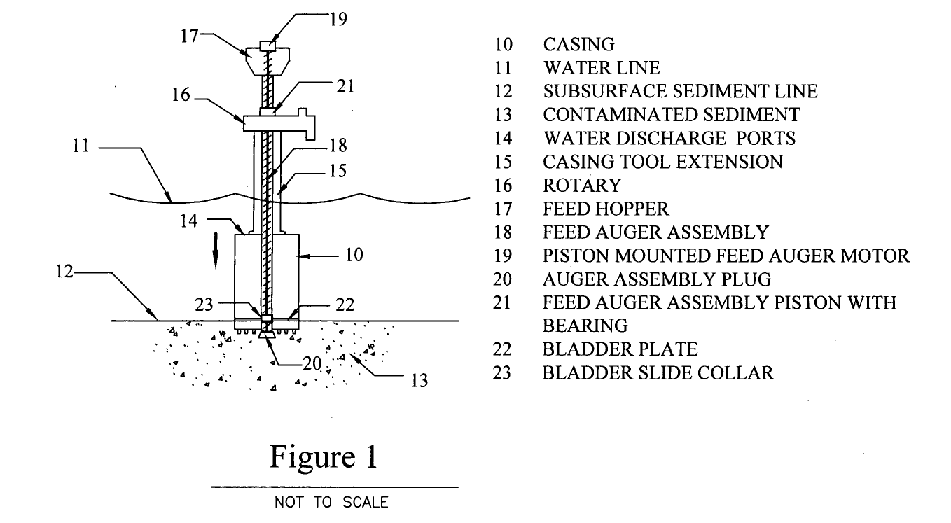

FIG. 1 depicts the rotating containment tool in an excavation mode of operation, where the casing 10 has descended below the water line 11 and has just penetrated the subsurface sediment line 12 to remove contaminated sediments 13. The casing 10 is equipped with pressure water discharge ports 14 at the top that provide the means to relieve internal pressure when sediment is forced into the housing.

The casing 10 is connected by means of a casing tool extension 15 to a rotary 16, which is driven by a rotary drilling machine (not shown) that rotates the casing tool extension 15 and the casing 10.

Extending from the bottom of the casing 10, up through the feed hopper 17, the inventors have incorporated a feed auger assembly 18. The feed auger assembly 18 houses an auger inside that delivers backfill or capping material to the excavated hole. The feed auger assembly 18 is housed inside the containment tool extension 15 from the top of casing 10 to the rotary 16. The auger is rotated by means of a piston-mounted feed auger motor 19.

An auger assembly plug 20 is connected to the bottom of the feed auger assembly 18. The auger assembly plug 20 prevents sediment from entering the feed auger assembly 18 during the rotating descent of the casing 10 into the sediment 13. Backfill can be introduced into an excavated hole by extending the feed auger assembly 18 downward below the bottom of the casing 10. This is accomplished with a feed auger assembly piston with bearing 21.

A bladder plate 22 is connected to a bladder slide collar 23, both of which are housed inside the casing 10. The bladder plate 22 acts to separate contaminated sediment 13 entering the casing 10 from overlying water. As the sediment 13 enters the casing 10 it forces the bladder slide collar 23 upward, forcing out the water through the water discharge ports 14.

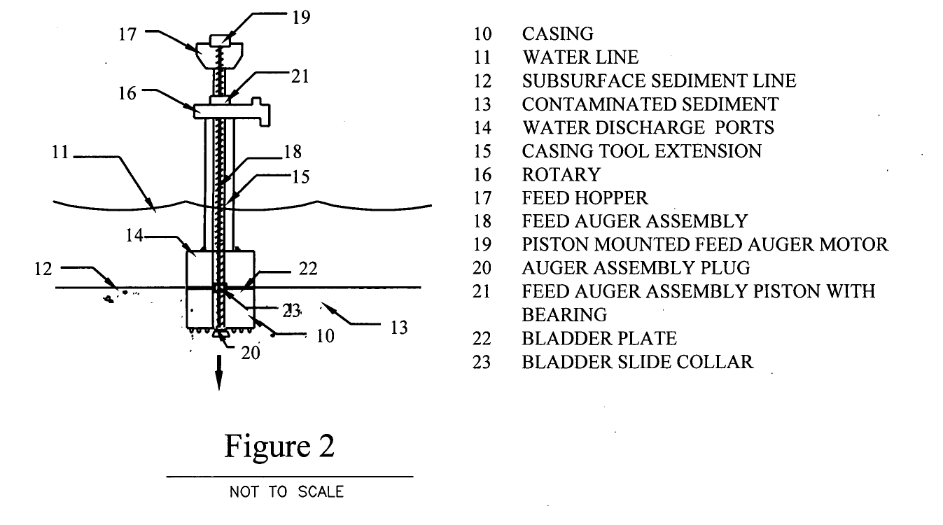

FIG. 2 depicts the rotating casing 10 in mid-penetration of the contaminated sediment 13. The bladder plate 22 is shown rising up into the casing 10 as the sediment enters into the casing 10.

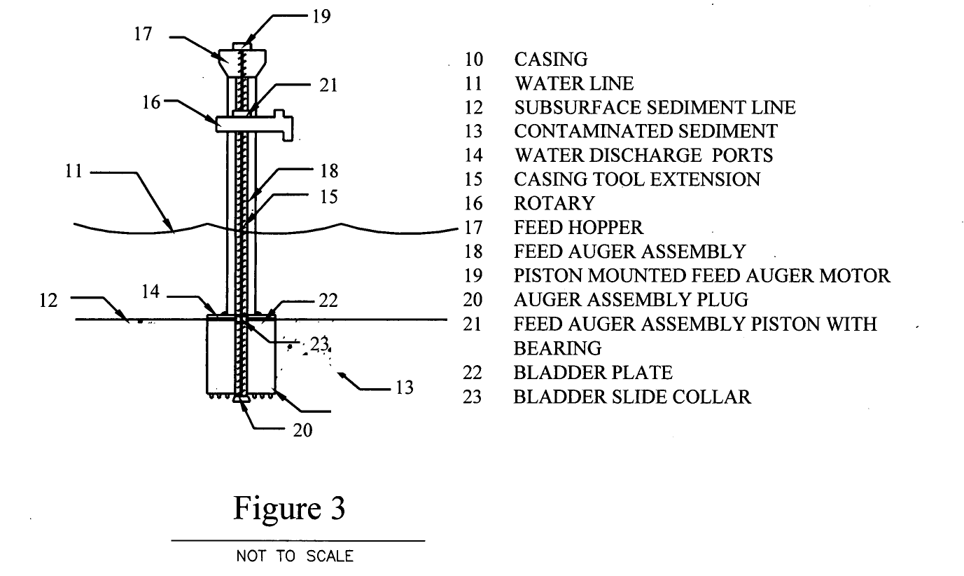

FIG. 3 depicts the rotating casing 10 fully penetrated into the contaminated sediment 13. The bladder plate 22 in this position is up near the top of the casing 10.

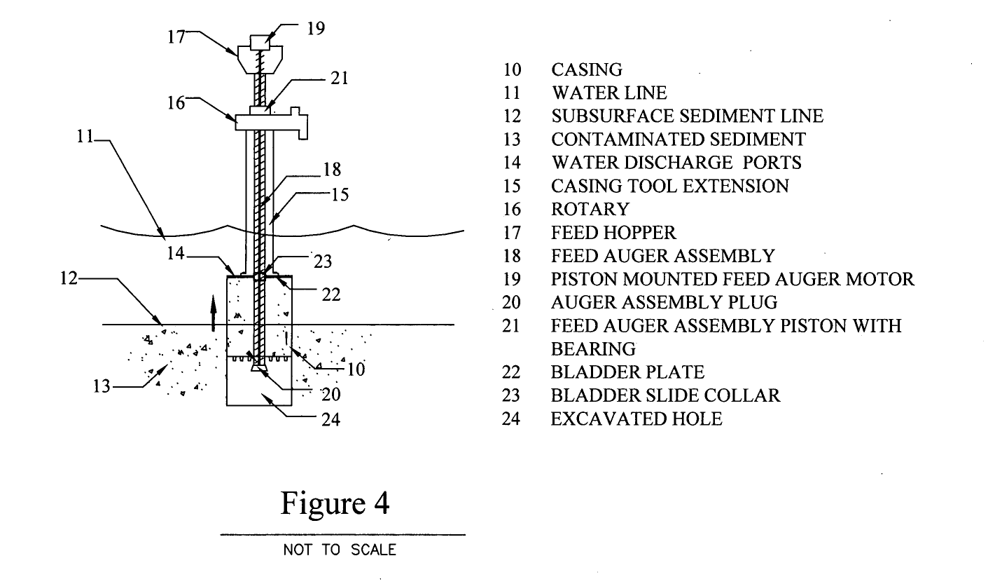

FIG. 4 depicts the casing 10 withdrawing from the excavated hole 24. In this position the feed auger assembly 18 is extended downward by the feed auger assembly piston with bearing 21, forcing the auger assembly plug 20 out of the bottom of the casing 10. Backfill material is fed into the feed hopper 17 from which it travels down the feed auger assembly 18 into the excavated hole 24. The bladder plate 22 is at the top of the casing 10.

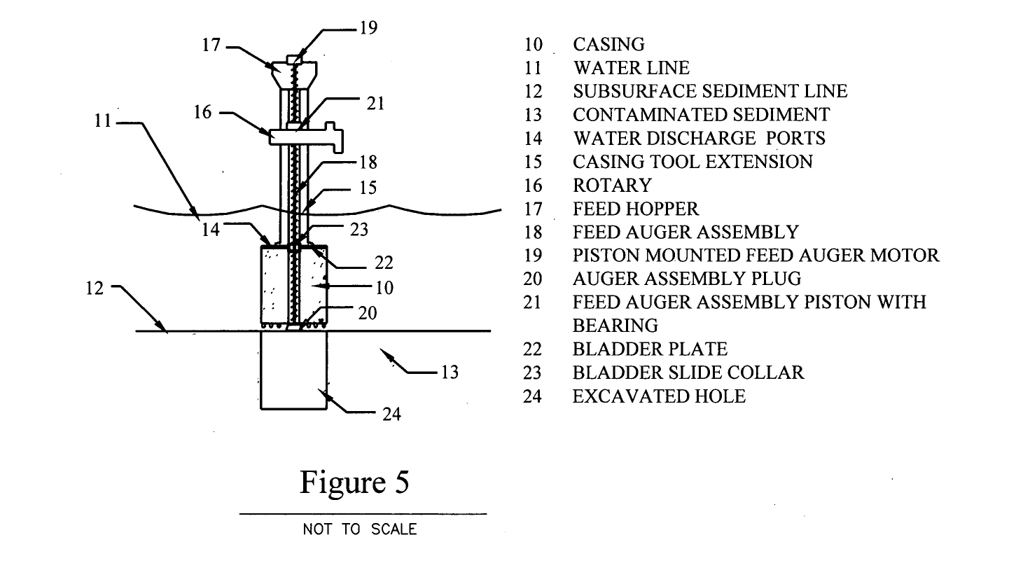

FIG. 5 depicts the casing 10 withdrawn above the subsurface sediment line 12. In this position the excavated hole 24 is fully backfilled and the casing 10 is ready for withdrawal to the surface to discharge its sediment load. The bladder plate 22 is located at the top of the casing 10.

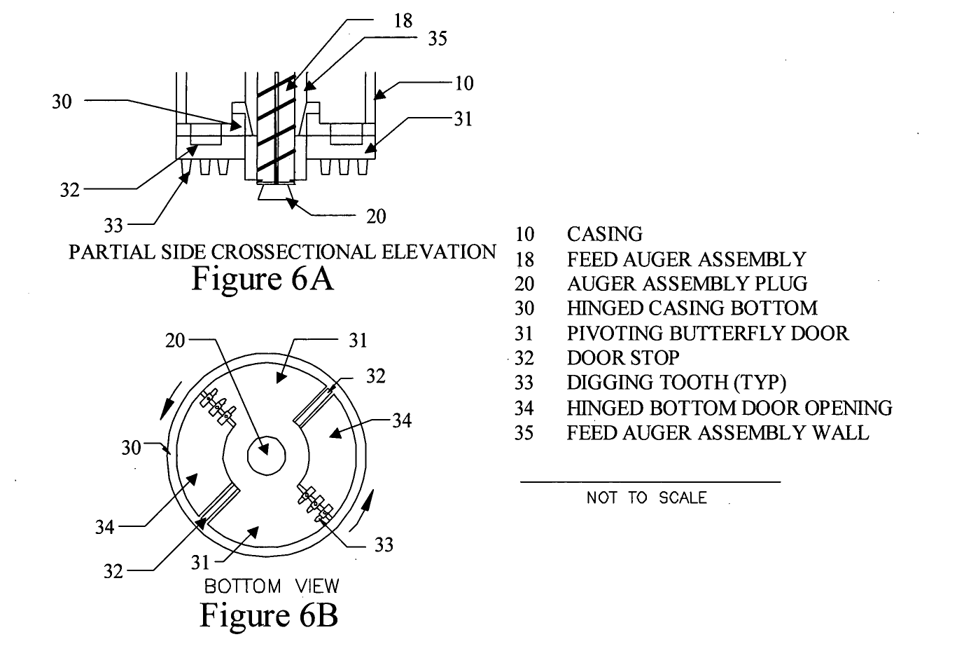

FIG. 6A depicts a partial side crossectional elevation view and FIG. 6B the bottom view of the casing 10. FIGS. 6A and 6B are designed to illustrate the presence of a hinged casing bottom 30. Attached to the hinged casing bottom 30 are pivoting butterfly doors 31 with a hollow pivot pin. The pivoting butterfly doors 31 are forced to the open position during descent with rotation counterclockwise as viewed from the bottom and is held in the open position by door stops 32. Digging teeth 33 assist in scooping the sediment into the rotating casing through the bottom door opening 34.

The partial side crossectional elevation view in FIG. 6A shows the feed auger assembly 18, the feed auger assembly wall 35, and the auger assembly plug 20. The hinged casing bottom 30 drops open during sediment discharge. For the bottom to open, the feed auger assembly 18 and auger assembly plug 20 must be drawn into the rotating casing housing. This is accomplished with the feed auger assembly piston with bearing 21 (shown in FIG. 1).

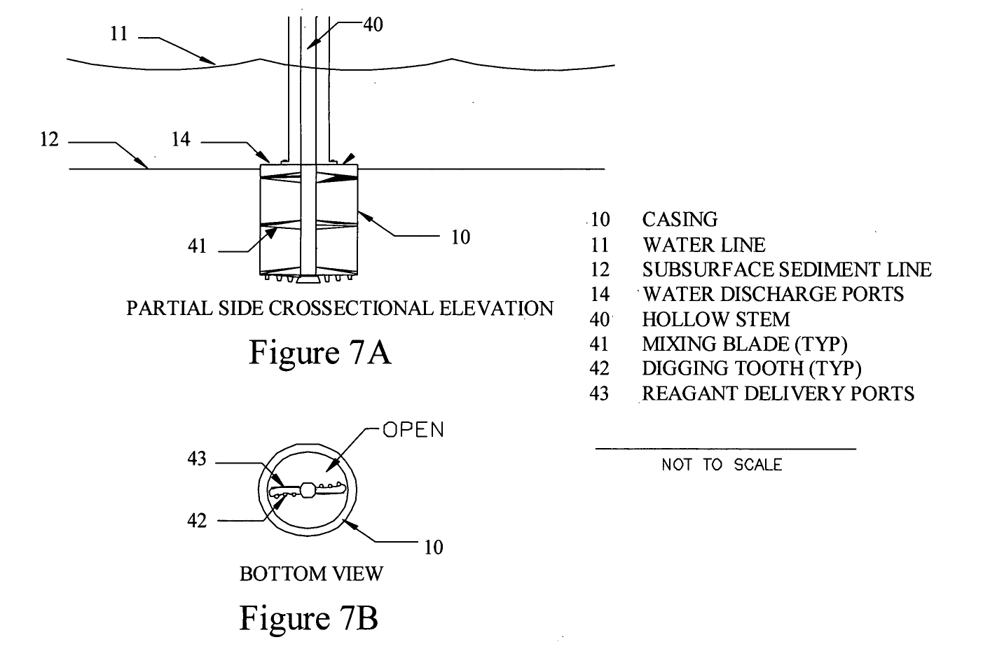

FIG. 7A depicts a partial side crossectional elevation view and FIG. 7B a bottom view of the casing 10 in an in-situ treatment mode of operation. In FIG. 7A, the rotating casing is shown to be descended below the water line 11 and below the subsurface sediment line 12 (water-sediment interface). The casing 10 is equipped with water discharge ports 14. A hollow stem 40 extends down into the casing 10 from the surface to provide the means to pump a liquid or slurry amendment into the sediment. Mixing blades 41 located inside the casing 10, and attached to the hollow stem 40 provide the means to mix the amendment with the sediment. The driving force for casing rotation is provided by a rotary drilling machine (not shown). The rotation and downward pressure of the drilling machine drives the casing into the sediment. The hollow stem 40 and mixing blades 41 are rotated by a piston mounted mixing drive (not shown). Digging teeth 42, located on the bottom mixing blade, shown in FIG. 7B, are used to rake and draw the sediment up into the rotating casing 10 and loosen it to enhance the blending efficiency of the mixing blades 41.

The mixing reagent is delivered to the sediment through the hollow stem 40, shown in FIG. 7A, and released through reagent delivery ports 43, located on the opposite end of the digging teeth 42, shown in FIG. 7B. Injection of a reagent, coupled with mixing of the sediment contained within the casing 10 will result in bulking (volumetric expansion) of the sediment. As a result, the casing 10 does not fully penetrate the sediment. Penetration to a depth of approximately 90 percent of the casing height leaves a space available inside the casing to accommodate for this expansion. The water discharge ports 14 provide for the release of pressurized water at the top of the casing 10. Water released can be discharged to the ambient environment or pumped to the surface for treatment to remove suspended solids that might become entrained in the water within the casing 10, if needed. Alternatively, a pressurized (compressed air) system can be employed, as described above, to maintain the casing water-free.

The reagent delivery configuration, shown in FIGS. 7A and 7B, assumes that the reagent used in the process is in a liquid or slurry form, capable of pressurized delivery into the sediment for mixing. It is expected that this will be the most common configuration. There may be instances, however, where the reagent is present in a more solid, particulate form. In such instances delivery would be provided by means of a feed auger, similar to the feed auger assembly 18 shown in FIGS. 1 through 5. Such a system would make use of mixing blades attached to the outside of the feed auger assembly to enhance the mixing of reagent particles with the sediment. In addition the capability to deliver solid material through the hollow stem provides the means to backfill the treated section, thereby capping the destabilized material to mitigate dispersion problems.

The general sequence of a rotating cylindrical casing remediation operation preferably involves the following activities:

1. Position the barge containing a rotary drilling machine capable of supporting the rotating cylindrical containment tool over the zone to be excavated.

2. Establish a primary and secondary grid treatment pattern.

3. Lower, insert and rotate the containment tool casing 10 to designated depth.

4. In an excavation mode, reverse the rotation of the casing 10, thereby closing the pivoting butterfly doors 31 to seal in the collected sediment.

5. Withdraw the casing 10 from the excavation, and simultaneous feed in backfill material into the excavated hole 24 to fill the void space and cap the location.

6. Withdraw the casing 10 with the sediment to the surface of the barge or land and swing the mast of the drilling machine over a container or drop area where the hinged casing bottom 30 can be opened to discharge the sediment.

7. Reposition the containment tool over the next designated hole to begin the process again.

8. In an in-situ treatment mode after Steps 1, 2 and 3, introduce reagent, under pressure into the hollow stem 40 of the containment tool and out the reagent delivery ports 43.

9. Rotate the mixing blades 41 to mix the reagent and sediments.

10. Introduce, if required solid reagent into or capping material above the treated area through the hollow stem of the mixing tool using a feed auger in accordance with step 5 above.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended claims.

What is claimed is:

1. A device for use in sub-aqueous environments to prevent dispersion and to provide for the removal of contaminated sediments comprising: a rotatable cylindrical casing, a capping material delivery system located within said cylindrical casing, and at least one water discharge port in said casing.

2. A device for use in sub-aqueous environments of claim 1 wherein, the rotatable casing is connected to a rotary.

3. A device for use in sub-aqueous environments of claim 2 wherein the rotatable casing is connected to a rotary via a casing tool extension extending upward from said rotatable casing.

4. A device for use in sub-aqueous environments of claim 3 wherein, the rotary is driven by a rotary drilling machine.

5. A device for use in sub-aqueous environments of claim 4 wherein the rotary rotates the casing tool extension and the casing.

6. A device for use in sub-aqueous environments of claim 5 wherein the casing is connected to a feed hopper.

7. A device for use in sub-aqueous environments of claim 6 wherein the feed hopper connects to said capping material delivery system comprised of a feed auger assembly, said feed auger assembly housing an auger inside that delivers at least one of backfill and/or capping material to the excavated hole.

8. A device for use in sub-aqueous environments of claim 7 wherein the feed auger assembly is housed inside the device for use in sub-aqueous environments via an extension in the casing, said feed auger assembly being spaced apart from an internal wall of said casing by an annular void accommodating contaminated sediment contacted by said auger assembly.

9. A device for use in sub-aqueous environments of claim 8 wherein the feed auger assembly houses an auger.

10. A device for use in sub-aqueous environments of claim 8 wherein the auger is rotated by means of a piston-mounted feed auger motor.

11. A device for use in sub-aqueous environments of claim 8 wherein the auger has an auger assembly plug preventing sediment from entering the feed auger assembly during use of the casing into the sediment.

12. A device for use in sub-aqueous environments of claim 8 wherein the casing has a bladder plate in the bottom of casing, said bladder plate separating contaminated sediment in the casing from overlying water.

13. A device for use in sub-aqueous environments of claim 12 wherein, the bladder plate is connected to, and moves adjacent to, a bladder slide collar inside the casing.

14. A device for use in sub-aqueous environments of claim 8 wherein, the feed auger assembly introduces backfill by extending downward below the cutting edge of the casing.

15. A device for use in sub-aqueous environments of claim 14 wherein, the feed auger assembly has at least one piston to extend the feed auger assembly.

16. A device for use in sub-aqueous environments to prevent dispersion and to provide for the in situ treatment of contaminated sediments comprising: a rotatable cylindrical casing, at least one reagent, a treatment mixing blade rotating within said cylindrical casing and at least one water discharge port in said casing.

17. A device for use in sub-aqueous environments to prevent dispersion and to provide remediation of contaminated sediments as in claim 16 wherein said reagent is at least one of a liquid, slurry or solid reagent, said mixing blade mixing said reagent with the contaminated sediment.

18. A device for use in sub-aqueous environments to prevent dispersion and to provide remediation of contaminated sediments as in claim 16 wherein said liquid or slurry mixing reagent is delivered to the sediment through a hollow stem and released through reagent delivery ports.

19. A device for use in sub-aqueous environments to prevent dispersion and to provide remediation of contaminated sediments as in claim 16 wherein said reagent is present in a solid, particulate form, said reagent provided by means of a feed auger assembly, said mixing blades being attached to the outside of said feed auger assembly, for mixing the reagent particles being delivered to the sediment.

20. A device for use in sub-aqueous environments to prevent dispersion and to provide remediation of contaminated sediments as in claim 16 wherein said particles are delivered through a hollow stem of said feed auger assembly to backfill the treated contaminated sediment, thereby capping the contaminated sediment.

21. A method of excavating contaminated sediment using a rotating containment tool comprising the steps of:
inserting a rotatable, cylindrical casing having a cutting edge into sediment; excavating the sediment with the cutting edge of the casing by rotating the containment tool casing;
permitting water to flow into and out of the casing based on external and internal pressures;
removing the sediment within the casing from the excavation site; and,
filling the excavated area by delivering backfill or capping material via an auger.

22. A method of excavating contaminated sediment as in claim 21, further comprising the step of opening rotating doors on the casing to permit the entrance of sediment as the casing rotates.

23. A method of excavating contaminated sediment as in claim 21, further comprising the steps of reversing the casing rotation and closing the doors once the casing as penetrated the sediment to a determined depth.

24. A method of excavating contaminated sediment as in claim 21, further comprising the step of preventing incoming sediment from mixing with overlying water in the external water column by operating a sliding bladder system.

25. A method of excavating contaminated sediment as in claim 21, further comprising the steps of discharging the contaminated sediment from the casing by lifting the casing out of the water and swinging it to at least one of a container and/or drop area.

26. A method of excavating contaminated sediment as in claim 21, further comprising the step of opening a hinged bottom of the casing and permitting the sediment to drop out of the casing.

27. A method of treatment for contaminated sediment in a sub-aqueous environment comprising the steps of;
establishing a primary and secondary grid treatment pattern;
inserting a rotatable, cylindrical casing having a cutting edge into sediment; extending a feed auger assembly from the bottom of the casing; rotating the auger assembly;
preventing sediment from entering the auger assembly; and treating the sediment.

28. A method of treatment for contaminated sediment in a sub-aqueous environment as in claim 27, further comprising the steps of introducing a remediation reagent via a hollow stem of the containment tool and reagent delivery ports.

29. A method of treatment for contaminated sediment in a sub-aqueous environment as in claim 28, further comprising the steps of rotating mixing blades in the casing and mixing the reagent and contaminated sediment.
